(19) United States
(12) Patent Application Publication
(10) Pub. No.: US 2008/0291228 A1
(43) Pub. Date: Nov. 27, 2008

(54) METHODS AND APPARATUS FOR INKJET PRINTING WITH MULTIPLE ROWS OF PRINT HEADS

(76) Inventors: JOHN M. WHITE, Hayward, CA (US); Fan-Cheung Sze, San Jose, CA (US); Quanyuan Shang, Saratoga, CA (US); Shinichi Kurita, San Jose, CA (US); Hongbin Ji, Santa Clara, CA (US); Janusz Jozwiak, San Ramos, CA (US); Inchen Huang, Fremont, CA (US); Emanuel Beer, San Jose, CA (US)

Correspondence Address: DUGAN & DUGAN, PC, 245 Saw Mill River Road, Suite 309, Hawthorne, NY, 10532, US

(21) Appl. No.: 11/751,231

(22) Filed: May 21, 2007

(51) Int. Cl. B41J 29/38; B41J 2/145

(52) U.S. Cl. 347/12; 347/40

(57) ABSTRACT

According to the present invention, multiple rows of nozzles within a print head may be arranged proximal to and offset from each other to facilitate inkjet printing. Print heads may comprise a single row of nozzles or may comprise a plurality of rows of nozzles. Each row of nozzles may be situated such that the immediately adjacent row of nozzles may be offset by a predetermined distance. In some embodiments, adjacent rows of nozzles may each print with the same color. In this way, adjacent offset rows of nozzles may be used in combination to dispense ink drops into sub-pixel wells in improved patterns and with improved ink distribution within the sub-pixel well. These offset print techniques may also enable tighter grouping of ink drops within a sub-pixel well and enable faster printing operations.

### CROSS REFERENCE TO RELATED APPLICATIONS

The present application is related to the following commonly-assigned, co-pending U.S. patent applications, each of which is hereby incorporated herein by reference in its entirety for all purposes:

U.S. patent application Ser. No. 11/019,967, filed Dec. 22, 2004 and titled “APPARATUS AND METHODS FOR AN INKJET HEAD SUPPORT HAVING AN INKJET HEAD CAPABLE OF INDEPENDENT LATERAL MOVEMENT” (Attorney Docket No. 9521);

U.S. patent application Ser. No. 11/019,929 filed Dec. 22, 2004 and titled “METHODS AND APPARATUS FOR INKJET PRINTING” (Attorney Docket No. 9521-02);

U.S. Patent Application Ser. No. 60/795,709 filed Apr. 29, 2006 and entitled “METHODS AND APPARATUS FOR INKJET PRINT HEAD PARKING STRUCTURES” (Attorney Docket No. 10648);

U.S. patent application Ser. No. 11/019,930 filed Dec. 22, 2004 and entitled “METHODS AND APPARATUS FOR ALIGNING PRINT HEADS” (Attorney Docket No. 9521-3);

U.S. patent application Ser. No. 11/123,502 filed May 4, 2005 and entitled “DROPLET VISUALIZATION OF INKJETTING” (Attorney Docket No. 9705);

U.S. patent application Ser. No. 11/212,043 filed Aug. 25, 2005 and entitled “METHODS AND APPARATUS FOR ALIGNING INKJET PRINT HEAD SUPPORTS” (Attorney Docket No. 9521-6);

U.S. patent application Ser. No. 11/238,631 filed Sep. 29, 2005 and entitled “METHODS AND APPARATUS FOR INKJET PRINT HEAD CLEANING” (Attorney Docket No. 9838);

U.S. patent application Ser. No. 11/466,507 filed Aug. 23, 2006 and entitled “METHOD AND APPARATUS FOR INKJET PRINTING COLOR FILTERS FOR DISPLAYS USING PATTERN DATA” (Attorney Docket No. 9521-P04);

U.S. patent application Ser. No. 11/521,177 filed Sep. 13, 2006 and entitled “METHOD AND APPARATUS FOR MANUFACTURING A PIXEL MATRIX OF A COLOR FILTER FOR A FLAT PANEL DISPLAY” (Attorney Docket No. 10502);

U.S. patent application Ser. No. 11/536,540 filed Sep. 28, 2006 and entitled “METHODS AND APPARATUS FOR ADJUSTING PIXEL PROFILES” (Attorney Docket No. 10448).

### FIELD OF THE INVENTION

The present invention relates generally to flat panel display manufacturing, and more particularly to methods and apparatus for inkjet printing.

### BACKGROUND

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. Accordingly, there is a need for improved methods and apparatus for efficiently positioning inkjet heads above drop locations on a substrate (e.g., so as to reduce the number of printing passes required for depositing ink on the substrate).

### SUMMARY OF THE INVENTION

In a first aspect of the invention, a system for inkjet printing is provided. The system includes at least one apparatus for inkjet printing having a first plurality of nozzles disposed in a row and adapted to selectively dispense ink and a second plurality of nozzles disposed in a row and adapted to selectively dispense ink. The first plurality of nozzles and the second plurality of nozzles are arranged adjacent each other and corresponding nozzles from the first and second rows dispense the same color ink into a same sub-pixel well on a substrate during a printing pass. The system also includes a stage adapted to support the substrate and transport the substrate below the at least one apparatus for inkjet printing during the printing pass.

In a second aspect of the invention, an apparatus for inkjet printing is provided. The apparatus includes a first row including a first plurality of nozzles adapted to selectively dispense ink and a second row including a second plurality of nozzles adapted to selectively dispense ink wherein the first row and the second row are disposed adjacent each other and are adapted to dispense ink into a same sub-pixel well on a substrate during a printing pass.

In a third aspect of the invention, a method of inkjet printing is provided. The method includes disposing a first plurality of inkjet nozzles in a first row, disposing a second plurality of inkjet nozzles in a second row adjacent the first row, and dispensing ink from corresponding nozzles in the first and second rows into a same sub-pixel well on a substrate during a printing pass.

In a third aspect of the invention, a method of inkjet printing is provided. The method includes rotating a first row of nozzles such that the first row of nozzles is a predetermined angle relative to a print direction, rotating a second row of nozzles substantially the same angle relative to the print direction as the first row of nozzles, and dispensing ink from the first and second rows of nozzles such that ink dispensed by corresponding nozzles in the first and second rows of nozzles is dispensed into a same sub-pixel well.

Other features and aspects of the present invention will become more fully apparent from the following detailed description, the appended claims and the accompanying drawings.

### BRIEF DESCRIPTION OF THE DRAWINGS

FIG. 1 is a schematic diagram of a system for inkjet printing in accordance with an embodiment of the present invention.

FIG. 2A is a schematic diagram of a top view of a portion of an apparatus for inkjet printing in accordance with an embodiment of the present invention.

FIG. 2B is a schematic diagram of an enlarged top view of a portion of the apparatus for inkjet printing shown in FIG. 2A in accordance with an embodiment of the present invention.

FIG. 3 illustrates a method of inkjet printing in accordance with an embodiment of the present invention.

FIG. 4 is a schematic diagram of a top view of an alternative embodiment of a portion of an inkjet printing apparatus in accordance with some embodiments of the present invention.

FIG. 5 is a schematic top view of exemplary completed print passes according to some embodiments of the present invention.

### DETAILED DESCRIPTION

The present invention provides methods and apparatus for improving inkjet printing by enabling a more complete fill of pixel wells on a substrate. According to the present invention, multiple rows of nozzles may be arranged to dispense ink onto a substrate as the substrate is transported below the nozzles. The rows of nozzles may be arranged such that ink drops dispensed from these rows may more completely fill a pixel and/or sub-pixel well on a substrate. This may be achieved by offsetting the rows of nozzles relative to each other in a direction perpendicular to the print direction by an offset amount (e.g., an offset distance). This offset distance may be a distance between corresponding nozzles on adjacent rows. Offsetting the rows of nozzles may allow the corresponding nozzles to each deposit ink into the same pixel well, though not in line with each other. This may allow more drops to fill the sub-pixel wells and/or fill areas unreached in prior applications.

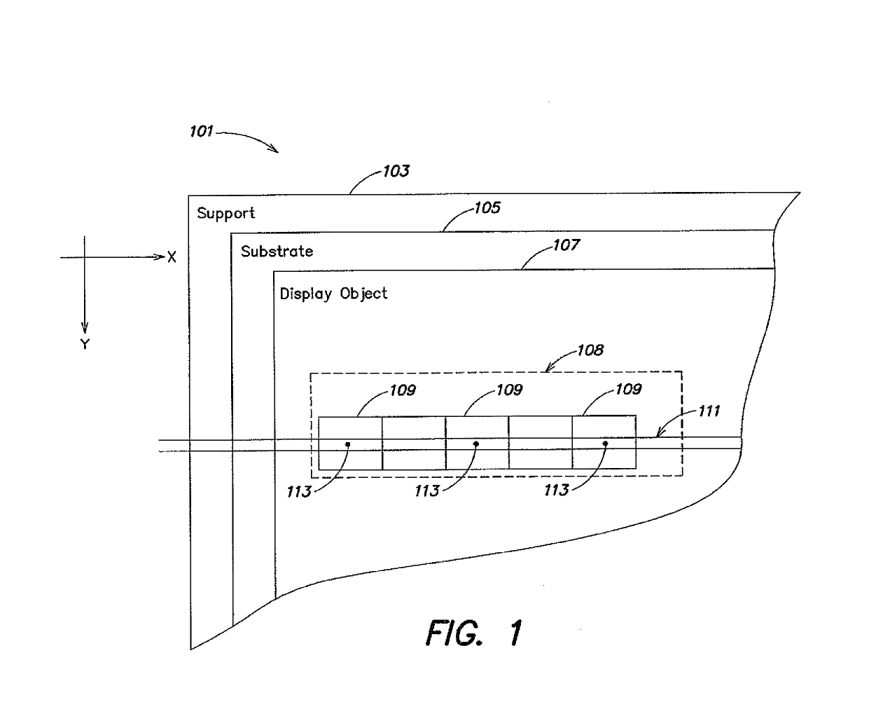

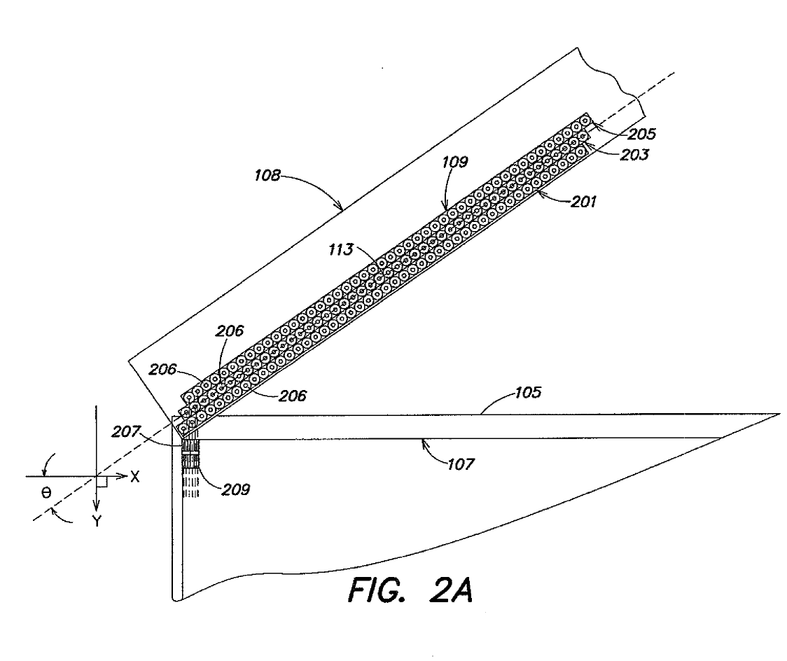

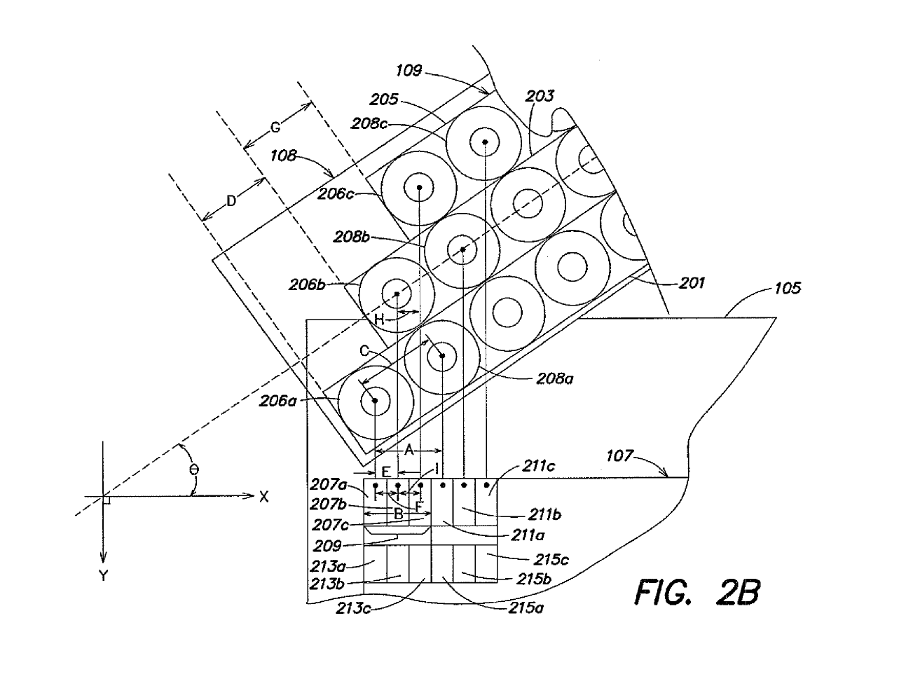

FIG. 1 is a schematic diagram of a system for inkjet printing in accordance with an embodiment of the present invention. With reference to FIG. 1, the system 101 may include a support 103 adapted to support and transport a substrate 105 during flat panel display manufacturing or the like, and more specifically, during inkjet printing. The substrate 105 may include one or more display objects 107 into which ink may be dispensed during inkjet printing. Details of the one or more display objects 107 of the substrate 105 are described below with reference to FIGS. 2A and 2B. While only one display object is shown in FIG. 1, it will be understood that the substrate 105 may include more than one display object. Note that a substrate 105 may be comprised of glass, polymers, and/or any other suitable material.

The system 101 may include one or more apparatus 108 for inkjet printing in accordance with an embodiment of the present invention. Each of the one or more apparatus 108 may include one or more sets 109 of inkjet print heads (not separately shown) adapted to dispense ink into the display objects 107 of the substrate 105. Although the example apparatus 108 includes three sets 109 of inkjet print heads, in some embodiments, the apparatus 108 may include a larger or smaller number of sets 109.

The one or more sets 109 of print heads may be coupled above the substrate support 103. More specifically, the system 101 for inkjet printing may include a rail 111, which extends above the support 103, to which the one or more sets 109 of print heads are coupled. As will be described below, each set 109 may be coupled to the rail 111 such that the set 109 may independently rotate (e.g., about a central axis 113) above the support 103. In addition, each set 109 may be independently moveable laterally (e.g., along an axis) above the support 103. Further, within each set 109, individual print heads may be moveable relative to each other, both along a longitudinal axis of the print heads and along an axis that is perpendicular to the longitudinal axis of the print heads.

During inkjet printing, the support 103 may transport the substrate 105 below the one or more sets 109 of inkjet print heads and such sets 109 of inkjet print heads may dispense one or more inks onto one or more display objects 107 included in the substrate 105. In some embodiments, the support 103 transports the substrate 105 along the y-axis, thereby defining a print direction. However, in other embodiments, the support 103 may transport the substrate 105 in a different direction. Each time the support 103 transports the substrate 105 below the one or more sets 109 may be referred to as a printing pass.

FIG. 2A is a schematic diagram of a top view of a portion of the apparatus 108 of FIG. 1. With reference to FIG. 2A, as stated, the apparatus 108 for inkjet printing may include one or more sets 109 of inkjet print heads (only one of which is shown in FIG. 2A). Each of the one or more sets 109 may include a plurality of inkjet print heads 201-205 adapted to dispense respective inks. More specifically, each print head 201-205 may include a plurality of nozzles 206 adapted to selectively dispense ink (e.g., red, green, blue and/or another color). In some embodiments, a set 109 may include three inkjet print heads 201-205 (although a larger or smaller number of inkjet print heads 201-205 may be employed). Further, in some embodiments, each of the inkjet print heads 201-205 may dispense different inks (e.g., inks of different colors) and/or other fluids or materials. However, in some embodiments, two or more of the print heads 201-205 may dispense the same ink (e.g., ink of the same color) and/or other fluids or materials.

The display object 107 may include a plurality of display pixels 209 each of which may include a plurality of color wells 207 into which ink may be dispensed. The plurality of inkjet print heads 201-205 in the set 109 may be arranged such that the set 109 is adapted to dispense a first ink from a first print head 201, a second ink from a second print head 203, and so on (e.g., a third ink from a third print head 205), into respective adjacent color wells 207 of a display pixel 209 on a substrate 105 during a printing pass. More specifically, to achieve the above result, the set 109 may be rotated (e.g., by an angle θ relative to an x-axis) about a central axis 113 (FIG. 1). Additionally or alternatively, one or more of the plurality of print heads 201-205 (e.g., the first 201 and third print heads 205) may be offset (e.g., along a longitudinal axis of such print heads 201, 205) from remaining print heads (e.g., the second print head 203) in the set 109. The rotating and/or offsetting of the print heads may be effected by independently operable drive motors (or other drivers) for each print head. Details of such rotating and/or offsetting are described below with reference to FIG. 2B.

Although rotating and/or offsetting are described below, it should be understood that any method may be employed to arrange the plurality of print heads 201-205 within each set 109 such that the set 109 is adapted to dispense a first ink from a first print head 201 and a second ink from a second print head 203 into respective adjacent color wells 207 of a display pixel 209. In other words, the rotating may be performed on individual print heads or on an entire set of print heads. Likewise, the offsetting may be performed on individual print heads or on an entire set of print heads. In this manner, a number of printing passes required to dispense the inks from the plurality of inkjet print heads 201-205 into respective adjacent color wells 207 of display pixels 209 on the substrate 105 during inkjet printing may be reduced. Likewise, although the examples described herein consider a set with three print heads and offsets based upon a center print head, any number of print heads may be employed and the center of the set may shift as differently sized sets with different numbers of print heads are employed. Also, although only one set 109 of the apparatus 108 for inkjet printing is illustrated in FIG. 2A, it should be understood that remaining sets 109 in the apparatus 108 are adapted to dispense ink in a similar manner into display pixels 209 traveling under such sets 109 during a printing pass.

FIG. 2B is a schematic diagram of an enlarged top view of a portion of the apparatus for inkjet printing shown in FIG. 2A in accordance with an embodiment of the present invention. With reference to FIG. 2B, the plurality of print heads 201-205 are arranged within the set 109 such that the set 109 may dispense a first ink from a first nozzle 206a of the first print head 201 into a first color well 207a, a second ink from a first nozzle 206b of the second print head 203 into a second color well 207b that is adjacent the first color well 207a, and so on (e.g., the set may be adapted to dispense a third ink from a first nozzle 206c of the third print head 205 into a third color well 207c that is adjacent the second color well 207b), as the support 103 transports the substrate 105 in the printing direction (e.g., along the y-axis) below the apparatus 108 (e.g., during a printing pass). Similarly, the set 109 may dispense ink into color wells of other display pixels 209. For example, the set 109 may dispense the first ink from a second nozzle 208a of the first print head 201 into a fourth color well 211a included in another display pixel, the second ink from a second nozzle 208b of the second print head 203 into a fifth color well 211b that is adjacent the fourth color well 211a, and so on (e.g., the set may be adapted to dispense the third ink from a second nozzle 208c of the third print head 205 into a sixth color well 211c that is adjacent the fifth color well 211b), during the printing pass. Further, the set 109 may dispense ink into color wells 213a-c, 215a-c as the support 103 transports such color wells below the set 109. In this manner, the set 109 may dispense ink into color wells 207a-c, 211a-c, 213a-c, 215a-c of display pixels 209 during the printing pass. Further, although FIG. 2B illustrates ink dispensed from two nozzles 206, 208 of each of the first through third print heads 201-205, it should be understood that the set 109 may be adapted to dispense ink from remaining nozzles of the plurality of print heads 201-205 in a manner similar to that described above such that ink may be deposited into one or more additional display pixels 209 (not shown) included in the display object 107 during the printing pass.

To achieve the above-described arrangement of the plurality of print heads 201-205 within the set 109, the set 109 may be rotated (e.g., by an angle θ relative to the x-axis) about a central axis (not shown in FIG. 2B; 113 in FIG. 2A) such that a center-to-center distance A along an axis (e.g., x-axis) perpendicular to the printing direction (e.g., y-axis) of adjacent nozzles in a print head 201-205 is substantially equal to the display pixel width B. In one embodiment, the display pixel width is 120 microns (although a larger or smaller width may be employed. In some embodiments, the angle of rotation θ may be cos⁻¹ (A/C), where C is the center-to-center distance between adjacent nozzles of a print head along a longitudinal axis of the print head as shown in FIG. 2B. However, the angle of rotation θ may be based on a different relationship.

Additionally or alternatively, the first print head 201 may be offset in a first direction (e.g., along a longitudinal axis of such print head 201) by an amount D from the second print head 203 such that a center-to-center distance E in a direction (e.g., along the x-axis) perpendicular to the print direction (e.g., along the y-axis) between corresponding nozzles (e.g., 206a and 206b) of such print heads 201-203 is approximately equal to a center-to-center distance F of adjacent color wells (e.g., 207a and 207b) of the display pixel 209.

Similarly, the third print head 205 may be offset in a second direction (e.g., along a longitudinal axis of such print head 201) by an amount G from the second print head 203 such that a center-to-center distance H in a direction (e.g., along the x-axis) perpendicular to the print direction (e.g., along the y-axis) between corresponding nozzles (e.g., 206c and 206b) of such print heads 203,205 is approximately equal to a center-to-center distance I of adjacent color wells (e.g., 207b and 207c) of the display pixel 209. In some embodiments, dimensions D, E and F may match dimensions G, H and I, respectively (although dimensions D, E and F may differ from dimensions G, H and I, respectively). Further, in some embodiments, the center-to-center distance F, I of adjacent color wells in a display pixel 209 may be about 360 microns (although a larger or smaller distance may be employed). Although only the arrangement of print heads 201-205 in one set 109 of the apparatus 108 for inkjet printing is illustrated in FIG. 2B, it should be understood that print heads in remaining sets 109 of the apparatus 108 may be arranged in a similar manner.

The offsetting may occur at the time the set 109 is calibrated and configured to print onto a particular display pixel layout of a display object. Alternatively, the offsetting may be performed during printing to accommodate different display objects or other requirements. The set 109 may include and/or be coupled to a driver to independently move the print heads to create the offset.

In some embodiments, multiple sets 109 of print heads may be employed simultaneously in a single print pass. For example, in a system for inkjet printing 101 according to the present invention, three sets 109 of print heads, each including three print heads (for a total of nine prints heads) may be arranged side by side and independently adjustable in a lateral direction. Thus, in operation, the simultaneous use of nine print heads according to the present invention may result in as few as one third the number of print passes being required to complete printing of a series of display objects 107 as compared to conventional systems. In some embodiments, multiple sets 109 may be employed to print on different display objects 107 simultaneously. For example, when printing on a substrate 105 that has a display object layout of three display objects 107 (e.g., three columns) by four display objects 107 (e.g., four rows), one set 109 per column of display objects 107 may be used to concurrently print each of the display objects 107 in a column. Thus, each set 109 of print heads may print a different column of display objects 107. Note that when printing on a substrate 105 that has a display object layout of, for example, five display objects 107 (e.g., five columns) by six display objects 107 (e.g., six rows), five sets 109 may be used concurrently to print the color filters in the most optimal manner. In all cases, the sets 109 may be independently adjustable in a lateral direction (e.g., along the x-axis, perpendicular to the print direction) to allow each set to be aligned with a different display object 107 and/or column of display objects 107. In some embodiments, all or a subset of all the sets 109 may concurrently print a single display object 107, for example, when a display object 107 is particularly large. Also note that the sets 109 may include a number of print heads that corresponds with the number of different color inks that may be used. In other words, if a display object 107 includes four colors, the sets 109 may include four print heads, one print head for each of the four colors.

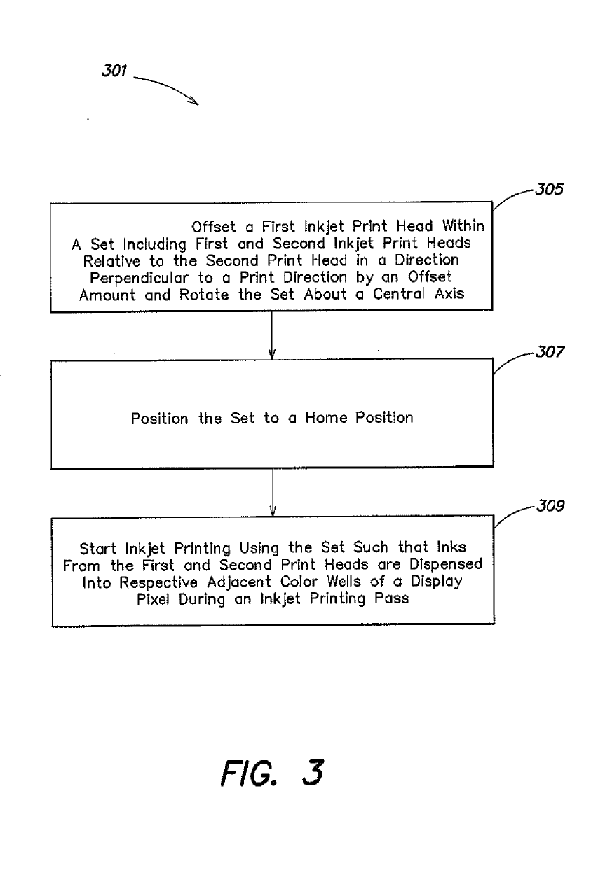

The operation of the system for inkjet printing is now described with reference to FIGS. 1-2B and with reference to FIG. 3, which illustrates a method 301 of inkjet printing in accordance with an embodiment of the present invention. With reference to FIG. 3, in step 305, at least one of a first inkjet print head within a set including first and second inkjet print heads is offset relative to the second print head in a direction perpendicular to a print direction by an offset amount. The set 109 is then rotated about a central axis. More specifically, the first inkjet print head 201 may be offset (e.g., via hardware or software) relative to the second print head 203 by an offset amount (e.g., a distance) D along a longitudinal axis of the print head 203. In this manner, the first print head 201 is offset from the second print head 203 in a direction (e.g., along the x-axis) perpendicular to the print direction (e.g., along the y-axis) so that a center-to-center distance E in the direction perpendicular to the printing direction between corresponding nozzles 206a, 206b of the first and second print heads 201-203 is approximately equal to a center-to-center distance F of adjacent color wells 207a, 207b of the display pixel 209 into which ink will be dispensed. Another print head (e.g., a third print head 205) may be offset from the second print head 203 in a similar manner.

The set 109 also may be rotated about the central axis (e.g., by an angle θ) such that a center-to-center distance A between adjacent nozzles (e.g., 206a, 208a) of a print head (e.g., 201) within the set 109 in a direction (e.g., along the x-axis) perpendicular to a print direction (e.g., along the y-axis) is substantially equal to the display pixel width B (FIG. 2B). By rotating the set 109 about a central axis 113 (e.g., by an angle θ), all print heads 201-205 included in the set 109 are rotated by the angle θ. Alternatively, in some embodiments, one or more of the print heads 201-205 may be rotated by the angle θ about respective central axes of such print heads 201-205 to achieve the above result.

In this manner, the print heads 201-205 in the set 109 are arranged for inkjet printing in accordance with an embodiment of the present invention. Thereafter, step 307 is performed.

In step 307, the set is positioned to a home position. For example, the substrate support 103 may be employed to move the substrate 105 to a position from which the apparatus 108 including the set 109 may start inkjet printing (e.g., the home position). The home position may be selected such that the apparatus 108 does not omit display pixels 209 on the display object 107 and may dispense ink to display pixels 209 on the display object 107 in an orderly fashion during inkjet printing using one or more printing passes. In some embodiments, this step 307 may be repeated for each of N sets 109 of print heads for each of N display objects 107 (or N columns of display objects 107) on the substrate 105. In some embodiments, each set 109 may be adjusted both laterally (e.g., along the x-axis) and along the print direction (e.g., along the y-axis) so as to position the different sets 109 so that they may print without a gap between the sets 109.

In step 309, inkjet printing using the set 109 is started such that inks from the first and second print heads are dispensed into respective adjacent color wells of a display pixel during an inkjet printing pass. For example, different inks (e.g., inks of different colors) may be dispensed from the first and second print heads 201-203, respectively, into adjacent color wells (e.g., 207a, 207b) during the printing pass. Although only one set is shown in FIGS. 2A-2B, it should be understood that a plurality of sets 109 may be employed to dispense ink into display pixels 209 of display objects 107 during inkjet printing. One or more printing passes may be employed to dispense ink into the display pixels 209 included in the display objects 107 of the substrate 105. Because inks from different print heads 201-205 (e.g., different inks) may be dispensed into adjacent color wells (e.g., 207a, 207b) of display pixels 209 in a display object 107 during a single printing pass using the present methods and apparatus, a total number of printing passes required to dispense ink into display pixels 209 on the substrate 105 may be reduced compared to conventional inkjet printing systems.

Through use of the method 301 inkjet printing may be improved by reducing a total number of printing passed required to dispense inks into display pixels 209 of display objects 107 included in a substrate 105. Compared to conventional systems, the present method improves inkjet printing efficiency and may reduce required maintenance.

The present invention further provides methods and apparatus for improved printing utilizing offset print techniques. Printing operations may be improved in that the print support may be moved more rapidly, ink distribution in a pixel may be improved (e.g., through a better fill profile and/or a more complete fill), and any Mura Effect may be reduced and/or eliminated. According to the present invention, multiple rows of nozzles within a print head may be arranged proximal to and offset from each other to facilitate inkjet printing. Print heads may comprise a single row of nozzles or may comprise a plurality of rows of nozzles. Each row of nozzles may be situated such that the immediately adjacent row of nozzles may be offset by a predetermined distance. In some embodiments, adjacent rows of nozzles may each print with the same color. In this way, adjacent offset rows of nozzles may be used in combination to dispense ink drops into sub-pixel wells in improved patterns and with improved ink distribution within the sub-pixel well. These offset print techniques may also enable tighter grouping of ink drops within a sub-pixel well and enable faster printing operations.

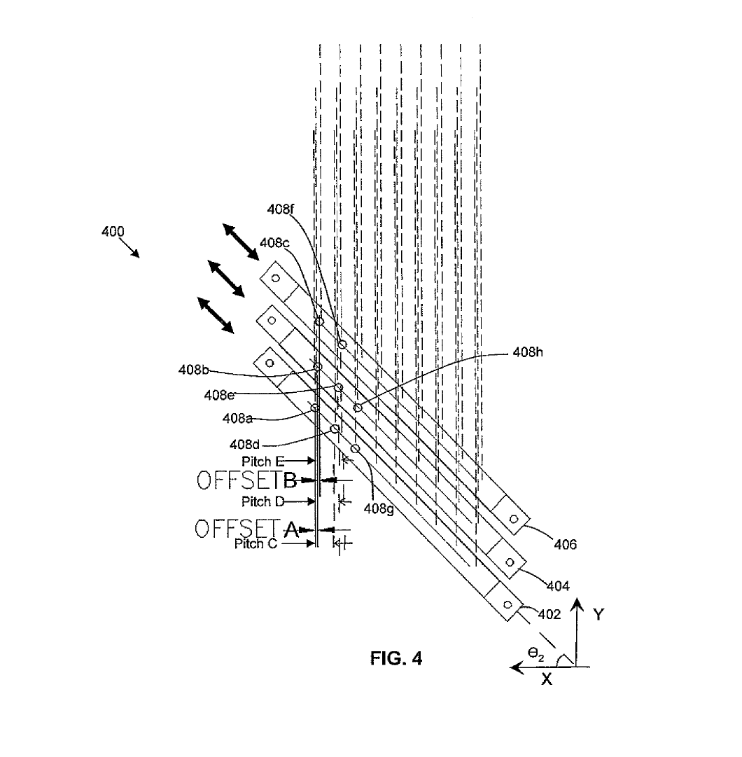

FIG. 4 is a schematic diagram of a top view of an alternative embodiment of a portion of an inkjet printing apparatus 400. The portion may be similar to inkjet printing apparatus 108 of FIG. 1 and/or retain some of the members of FIGS. 1, 2A, and 2B. In FIG. 4, multiple rows of nozzles 402, 404, 406 are shown which are adapted to dispense respective inks. Specifically, each row of nozzles 402-406 may include a plurality of nozzles 408a-h adapted to selectively dispense ink (e.g., red, green, blue and/or another color). Any appropriate number of nozzles (e.g., 10, 50, 64, 100, 124, etc.) 408a-h may be arranged in the rows of nozzles 402-406. In some embodiments, multiple sub-rows (not shown) of nozzles 408a-h may be arranged adjacent one another in a single row of nozzles 402-406. Other patterns of nozzles 408a-h may also be used (e.g., a cluster, pyramid, etc.). Similarly, any number of rows of nozzles 402-406 may be arranged adjacent one another. These rows of nozzles 402-406 may be part of a print head 201-205 as shown in FIGS. 1, 2A, and 2B or may be independent. Further, in some embodiments, each of the rows of nozzles 402-406 may dispense different inks (e.g., inks of different colors) and/or other fluids or materials. However, in some embodiments, two or more of the rows of nozzles 402-406 may dispense the same ink (e.g., ink of the same color) and/or other fluids or materials.

Rows of nozzles 402-406 may be offset from each other by an offset distance. The offset distance may be measured as the center-to-center distance between corresponding nozzles on different rows of nozzles, measured along a stationary axis (e.g., the x-axis indicated in FIG. 4). In the exemplary embodiment of FIG. 4, the row of nozzles 404 may be offset from the row of nozzles by an offset A. That is, the center-to-center distance between the first nozzle 408a of row of nozzles 402 and the first nozzle 408b of row of nozzles 404 along the x-axis may be a distance A. Similarly, the row of nozzles 406 may be offset from the row of nozzles 402 by an offset B. That is, the center-to-center distance between the first nozzle 408a of row of nozzles 402 and the first nozzle 408c of row of nozzles 406 along the x-axis may be a distance B. Rows of nozzles 402-406 may be rotated and/or offset as described above with respect to print heads 201-205 FIGS. 2A and 2B. Specifically, rows of nozzles 402-406 may be shifted along a longitudinal axis of each row of nozzles to achieve the desired offset. In some embodiments, the offsets A, B may be in a range of about 20 microns to about 80 microns. In a preferred embodiment, the offset distance may be about 60 microns. Greater or smaller offset distances may be used (e.g., about 0-20 microns, 80-1000 microns, etc.). Offset distances A, B may be measured along the positive or negative x-axis or along any other axis (e.g., the y-axis of FIG. 4, a longitudinal axis as shown in FIG. 2B, etc.) such that the offset may be an absolute value that does not indicate which row of nozzles 402-406 has been shifted or which direction the rows were shifted. In other embodiments, the offset may reflect the direction and row of nozzles that has been shifted (e.g., row of nozzles 404 offset by −60 microns may indicate the row of nozzles 402 is the reference point and the row of nozzles 404 is shifted 60 microns in the negative x direction).

Nozzles within the same row may have a pitch wherein the pitch is a distance reflective of the angle at which the row of nozzles is situated relative to a stationary axis. For example, row of nozzles 402 may have a pitch C, which is the center-to-center distance between nozzle 408a (e.g., the first nozzle of row of nozzles 402) and nozzle 408d (e.g., the second nozzle of row of nozzles 402) along the x-axis. Similarly, row of nozzles 404 may have a pitch D, which is the center-to-center distance between nozzle 408b (e.g., the first nozzle of row of nozzles 404) along the x-axis and nozzle 408e (e.g., the second nozzle of row of nozzles 404) and row of nozzles 406 may have a pitch E, which is the center-to-center distance between nozzle 408c (e.g., the first nozzle of row of nozzles 406) and nozzle 408f (e.g., the second nozzle of row of nozzles 406) along the x-axis. Pitches C, D, and E, in some embodiments, may be approximately equal. That is, the rows of nozzles 402-406 may have approximately the same spacing between respective nozzles within their rows and the rows 402-406 may all be rotated (e.g., by an angle θ₂) such that they have approximately the same relative angle to the x-axis. In the improved printing techniques of the present invention, the pitch may be significantly reduced; this reduction may facilitate faster printing. In one embodiment, the pitch may be about five millimeters instead of a currently common pitch of about 400 millimeters. Greater or smaller pitches may be desirable and/or achievable.

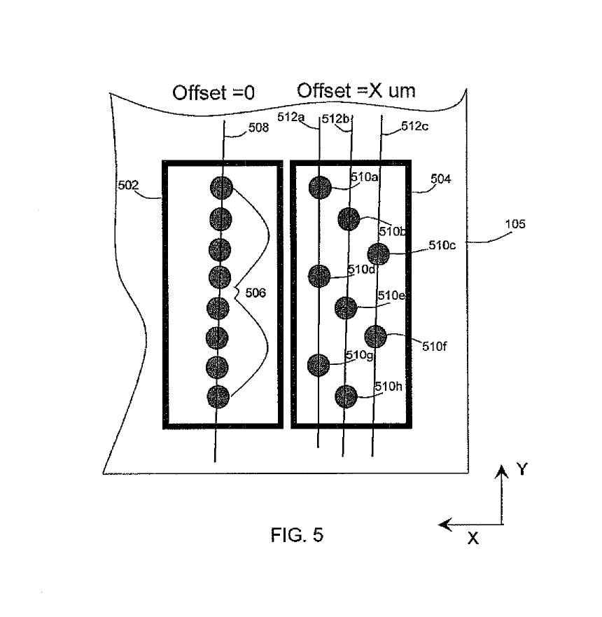

Turning to FIG. 5, a schematic top view of exemplary completed print passes according to some embodiments of the present invention are depicted. During printing operations according to the arrangements and apparatus of FIG. 4, printing may be completed to a display object 105, as in FIGS. 1-2B. Ink may be dispensed into sub-pixel wells 502, 504. Ink drops 506 may be dispensed in sub-pixel well 502 along a print line 508. Ink drops 510a-h may be dispensed in sub-pixel well 504 along print lines 512a-c.

In operation, when printing with an offset of zero microns, ink drops 506 may be dispensed about along a print line 508. That is, the ink drops 506 will approximately follow an axis that, in some embodiments, will correlate to approximately parallel to the y-axis shown in FIGS. 4 and 5. To achieve an offset of about zero microns, rows of nozzles 402-406 may be substantially parallel to the x-axis of FIGS. 4 and 5. Additionally or alternatively, the rows of nozzles 402-406 may be rotated and offset such that dispensed ink drops 506 are printed along the print line 508. In some cases, when ink drops 506 are in a consistent print line 508, even if the print line 508 is not parallel to the y-axis, the cumulative effect of the print line 508 may result in a Mura Effect. That is, the display object may reflect a visible cue that the ink drops 506 are in a consistent and, in some cases, undesirable line.

In further print operations, to achieve a more complete fill profile, speed stage motion and/or print speed, and/or improve ink distribution the rows of nozzles of FIG. 4 may be rotated and/or offset by certain angles and/or offset distances (e.g., X microns). In an exemplary embodiment, when the display object 105 is moved in a print direction that corresponds with the positive y-axis, as indicated in FIGS. 4 and 5, nozzle 408a may dispense ink drop 510a into sub-pixel well 504 along print line 512a. In short order, nozzle 408b, which has an offset A, may dispense ink drop 510b into sub-pixel well 504 along print line 512b. Nozzle 408c, which has an offset B, may then dispense ink drop 510c into sub-pixel well 504 along print line 512c. At an appropriate interval after printing ink drop 510a, nozzle 408a may dispense ink drop 510d along print line 512a. Printing ink drop 510d may occur before printing ink drops 510b, 510c, or after printing these drops. In this way, printing speed may be greatly increased as the print pass moves in the positive y-direction because the row of nozzles 402 is backed by row of nozzles 404, etc., such that the individual nozzles 408a-f may print less frequently. Nozzle 408b may then dispense ink drop 510e along print line 512b. Following the printing of ink drop 510e, nozzle 408c may dispense ink drop 510f along print line 512c. Similarly, nozzles 408a and 408b may print ink drops 510g and 510h, respectively, along respective print lines 512a and 512b.

Using this pattern and method of printing, ink drops 510a-h may more completely fill the sub-pixel well 504. Similarly, because the ink drops 510a-h are dispensed in multiple locations in the sub-pixel well 504, different fill profiles (e.g., concave, convex, flat, etc.) may be achieved. It should be understood that greater or smaller number of rows of nozzles 402-406, nozzles 408a-h, and ink drops 510a-h might be used. For example, in an exemplary alternative embodiment, three rows of nozzles 402-406 may utilize three nozzles 408a-c to dispense ink drops 510a-c and 510g-h.

Additionally, the present inventive apparatus and methods of printing may be useful when printing to alternative pixel well and sub-pixel well shapes. For example, when chevron, honeycomb, non-rectangular parallelogram, or other pixel well and sub-pixel well are used, the inventive methods and apparatus may be used to dispense ink drops into areas not normally reached during a standard zero offset or straight line print.

Utilizing multiple print lines 512a-c which, in some embodiments, may not be parallel to each other may eliminate Mura Effect described above. Additionally or alternatively, the use of multiple print lines that are non-parallel may enable or enhance printing to pixel shapes that are not rectangular.

The foregoing description discloses only exemplary embodiments of the invention. Modifications of the above disclosed apparatus and methods which fall within the scope of the invention will be readily apparent to those of ordinary skill in the art. For instance, in one or more embodiments, the inkjet heads 201-205 may move during printing while the substrate 105 remains stationary. In some embodiments, the apparatus and methods of the present invention may be applied to semiconductor processing and/or electronic device manufacturing. For example, resist patterns may be inkjetted onto substrates which may include glass, polymers, semiconductors, and/or any other suitable materials that are practicable. Thus, the jetted material may include ink, polymers, or any other suitable material that is practicable.

Accordingly, while the present invention has been disclosed in connection with exemplary embodiments thereof, it should be understood that other embodiments may fall within the spirit and scope of the invention, as defined by the following claims.

The invention claimed is:

1. A system for inkjet printing, comprising:
at least one apparatus for inkjet printing having:
a first plurality of nozzles disposed in a row and adapted to selectively dispense ink;
a second plurality of nozzles disposed in a row and adapted to selectively dispense ink;
wherein the first plurality of nozzles and the second plurality of nozzles are arranged adjacent each other and corresponding nozzles from the first and second rows dispense the same color ink into a same sub-pixel well on a substrate during a printing pass; and,
a stage adapted to support the substrate and transport the substrate below the at least one apparatus for inkjet printing during the printing pass.

2. The system of claim 1 further comprising a third plurality of nozzles disposed in a row and adapted to selectively dispense ink,
wherein the first plurality of nozzles, the second plurality of nozzles, and the third plurality of nozzles are arranged adjacent each other and corresponding nozzles from the first, second, and third rows dispense the same color ink into the same sub-pixel well on the substrate during the printing pass.

3. The system of claim 1 wherein the second row of nozzles is adapted to be offset relative to the first row of nozzles in a direction perpendicular to a print direction by an offset amount.

4. The system of claim 1 wherein the at least one apparatus is further adapted to offset the second row of nozzles relative to the first row of nozzles in a direction perpendicular to a print direction by an amount such that a center-to-center distance in the direction perpendicular to the print direction between corresponding nozzles of the first and second rows of nozzles is in a range of about 20 microns to about 80 microns.

5. The system of claim 1 wherein the at least one apparatus is further adapted to offset the second row of nozzles relative to the first row of nozzles in a direction perpendicular to a print direction by an amount such that a center-to-center distance in the direction perpendicular to the print direction between corresponding nozzles of the first and second rows of nozzles is about 60 microns.

6. The system of claim 1 wherein the at least one apparatus is further adapted to reduce a number of printing passes required to dispense ink into sub-pixel wells of display pixels on the substrate during inkjet printing by printing a first print line from a first nozzle of the first row of nozzles into a sub-pixel well and printing an adjacent second print line from a first nozzle of the second row of nozzles into the same sub-pixel well.

7. An apparatus for inkjet printing, comprising:
a first row including a first plurality of nozzles adapted to selectively dispense ink;
a second row including a second plurality of nozzles adapted to selectively dispense ink; and,
wherein the first row and the second row are disposed adjacent each other and are adapted to dispense ink into a same sub-pixel well on a substrate during a printing pass.

8. The apparatus of claim 7 wherein the second row of nozzles is adapted to be offset relative to the first row of nozzles in a direction perpendicular to a print direction by an offset amount.

9. The apparatus of claim 7 wherein the first and second rows are movable to offset the second row relative to the first row in a direction perpendicular to a print direction by an amount such that a center-to-center distance in the direction perpendicular to the print direction between corresponding nozzles of the first and second rows of nozzles is in a range of about 20 microns to about 80 microns.

10. The apparatus of claim 7 wherein the first and second rows are movable to offset the second row relative to the first row in a direction perpendicular to a print direction by an amount such that a center-to-center distance in the direction perpendicular to the print direction between corresponding nozzles of the first and second rows of nozzles is about 60 microns.

11. The apparatus of claim 7 wherein the first and second rows are further adapted to reduce a number of printing passes required to dispense the ink into sub-pixel wells on the substrate during inkjet printing by printing a first print line from a first nozzle of the first row into a sub-pixel well and printing an adjacent second print line from a first nozzle of the second row into the same sub-pixel well.

12. A method of inkjet printing, comprising:
disposing a first plurality of inkjet nozzles in a first row;
disposing a second plurality of inkjet nozzles in a second row adjacent the first row; and,
dispensing ink from corresponding nozzles in the first and second rows into a same sub-pixel well on a substrate during a printing pass.

13. The method of claim 12 further comprising offsetting the first and second rows from each other prior to dispensing ink from corresponding nozzles in the first and second rows.

14. The method of claim 12 further comprising offsetting the second row relative to the first row in a direction perpendicular to a print direction by an amount such that a center-to-center distance in the direction perpendicular to the print direction between corresponding nozzles of the first and second rows of nozzles is in a range of about 20 microns to about 80 microns.

15. The method of claim 12 further comprising offsetting the second row relative to the first row in a direction perpendicular to a print direction by an amount such that a center-to-center distance in the direction perpendicular to the print direction between corresponding nozzles of the first and second rows of nozzles is about 60 microns.

16. The method of claim 12 further comprising:
printing a first print line from a first nozzle of the first row into a sub-pixel well; and,
printing an adjacent second print line from a first nozzle of the second row into the same sub-pixel well.

17. A method of inkjet printing, comprising:
rotating a first row of nozzles such that the first row of nozzles is a predetermined angle relative to a print direction;
rotating a second row of nozzles substantially the same angle relative to the print direction as the first row of nozzles; and,
dispensing ink from the first and second rows of nozzles such that ink dispensed by corresponding nozzles in the first and second rows of nozzles is dispensed into a same sub-pixel well.

18. The method of claim 17 further comprising rotating a third row of nozzles substantially the same angle relative to the print direction as the first row of nozzles and dispensing ink from the first, second, and third rows of nozzles such that ink dispensed by corresponding nozzles in the first, second, and third rows of nozzles is dispensed into a same sub-pixel well.

19. The method of claim 17 further comprising offsetting the second row of nozzles relative to the first row of nozzles in a direction perpendicular to the print direction by an offset amount prior to dispensing ink from the first and second rows of nozzles.

20. The method of claim 19 wherein:
offsetting the second row of nozzles relative to the first row of nozzles in a direction perpendicular to the print direction by an offset amount includes offsetting the second row relative to the first row in the direction perpendicular to the print direction by an amount such that a center-to-center distance in the direction perpendicular to the print direction between corresponding nozzles of the first and second rows is sufficiently small so as to allow the corresponding nozzles to print adjacent print lines in the same sub-pixel well.
